(19) United States
(12) Patent Application Publication
(10) Pub. No.: US 2021/0157110 A1
(43) Pub. Date: May 27, 2021

(54) ZOOM LENS AND MANUFACTURING METHOD THEREOF

(71) Applicant: Coretronic Corporation, Hsin-Chu (TW)

(72) Inventor: Meng-Feng Chung, Hsin-Chu (TW)

(73) Assignee: Coretronic Corporation, Hsin-Chu (TW)

(21) Appl. No.: 17/098,454

(22) Filed: Nov. 16, 2020

(30) Foreign Application Priority Data
Nov. 27, 2019 (CN) 201911179299.0

(51) Int. Cl. G02B 15/14; G02B 15/16; G02B 13/18

(52) U.S. Cl. CPC G02B 15/1425; G02B 13/18; G02B 15/16

(57) ABSTRACT

A zoom lens including a movable first lens group and a movable second lens group sequentially arranged along an optical axis from a magnifying side to a reduction side is provided. The first lens group and the second lens group respectively includes at least one lens. The zoom lens meets a condition, and the condition is: a product of a refractive index temperature coefficient and a refractive index temperature coefficient change rate of at least some of the lenses in the first lens group and the second lens group is less than 0. In addition, a manufacturing method of a zoom lens is also provided. The zoom lens and the manufacturing method thereof provided in the invention can achieve favorable and consistent imaging quality in both a high temperature environment and a low temperature environment under different modes.

### CROSS-REFERENCE TO RELATED APPLICATION

This application claims the priority benefit of China application serial no. 201911179299.0, filed on Nov. 27, 2019. The entirety of the above-mentioned patent application is hereby incorporated by reference herein and made a part of this specification.

### BACKGROUND OF THE INVENTION

### 1. Field of the Invention

The invention relates to a lens and a manufacturing method thereof, and in particular, to a zoom lens and a manufacturing method thereof.

### 2. Description of Related Art

With the development of science and technology, projectors are widely used in a variety of different places, for example, homes, movie theaters, or large outdoor venues, and other places. A zoom lens may change a size of a projection image by changing a focal length of the zoom lens without changing a projection distance, so that a projector may be more flexibly and conveniently mounted. Therefore, zoom lenses are widely applied to projectors to enable the projectors to be applicable in different places. On the other hand, with the progress of science and technology, consumers have increasingly higher requirements on brightness of projection images. Therefore, in recent years, demands for projectors with both high brightness and zoom capabilities are increasing.

As the trend of high brightness projector develops, an influence of a thermal effect of a projection lens becomes more obvious. The thermal effect makes a temperature inside the projector increasingly higher, to be specific, the temperature inside the projector changes from a normal temperature to a high temperature with an operation time, leading to two consequences. On the one hand, the change in the temperature causes thermal deformation and thermal stress of a light machine, a lens barrel, and the lens. On the other hand, a refractive index of the lens changes with the temperature.

FIG. 1A and FIG. 1B respectively represent schematic diagrams of optical simulation of a known zoom lens at a normal temperature and a high temperature. A horizontal axis represents focal plane displacement (unit: mm), and a vertical axis represents function values of a modulation transfer function (MTF). It may be learned from FIG. 1A that, in a normal temperature environment, focal plane displacement (or referred to as focus displacement) of the known zoom lens at a wide-angle end (or referred to as a wide-angle mode) and focal plane displacement at a telephoto end (or referred to as a telephoto mode) are similar, in other words, in the normal temperature environment, imaging quality of the zoom lens at the wide-angle end and the telephoto end are more consistent. However, it is learned from FIG. 1B that, in a high temperature environment, focal plane displacement of the known zoom lens at the wide-angle end and focal plane displacement at the telephoto end differ a lot, in other words, in the high temperature environment, imaging quality of the zoom lens at the wide-angle end and the telephoto end are more inconsistent.

In addition, a lens group inside the zoom lens usually moves along an optical axis to implement a zoom function. Because the lens group is close to a heat source (for example, a laser source), a slight change in distances between lenses inside the lens group causes a large change in a temperature gradient in space, that is, a temperature distribution at the telephoto end is significantly different from that at the wide-angle end, and such a phenomenon of different temperature distributions also causes different imaging quality at the wide-angle end and the telephoto end, affecting the imaging quality.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY OF THE INVENTION

The invention provides a zoom lens, which has favorable and consistent imaging quality in both a high temperature environment and a low temperature environment in different modes (at a wide-angle end and a telephoto end).

The invention provides a manufacturing method for manufacturing the foregoing zoom lens.

Other objectives and advantages of the invention may be further understood from technical features disclosed in the invention.

To achieve one or some or all of the foregoing objectives or other objectives, an embodiment of the invention provides a zoom lens, sequentially provided with a movable first lens group and a movable second lens group along an optical axis from a magnifying side (MS) to a reduction side (RS), and the first lens group and the second lens group each include at least one lens. The zoom lens meets a condition, and the condition is: products of refractive index temperature coefficients and refractive index temperature coefficient change rates of at least some of the lenses in the first lens group and the second lens group are less than 0.

To achieve one or some or all of the foregoing objectives or other objectives, an embodiment of the invention provides a manufacturing method of a zoom lens, including: providing a preset zoom lens; obtaining a wide-angle end temperature distribution of each preset lens in the preset zoom lens at a wide-angle end and a telephoto end temperature distribution of each preset lens in the preset zoom lens at a telephoto end; obtaining wide-angle end focal plane displacement of each preset lens at the wide-angle end, telephoto end focal plane displacement of each preset lens at the telephoto end, total wide-angle end focal plane displacement of the preset zoom lens, and total telephoto end focal plane displacement of the preset zoom lens according to the wide-angle end temperature distribution and the telephoto end temperature distribution; performing a first adjustment on refractive indexes of at least some preset lenses in the preset zoom lens according to the wide-angle end focal plane displacement of each preset lens, the telephoto end focal plane displacement of each preset lens, the total wide-angle end plane displacement of the preset zoom lens, and the total telephoto end plane displacement of the preset zoom lens, to adjust the preset zoom lens to a first adjustment zoom lens, where each lens in the first adjustment zoom lens is a first adjustment lens; and performing a second adjustment on at least some first adjustment lenses in the first adjustment zoom lens according to the wide-angle end temperature distribution, the telephoto end temperature distribution, a refractive index of each first adjustment lens, and a position of each first adjustment lens, to obtain the zoom lens, where the zoom lens meets the following condition: products of refractive index temperature coefficients and refractive index temperature coefficient change rates of at least some lenses of the zoom lens are less than 0.

Based on the above, in the zoom lens and the manufacturing method thereof in the embodiments of the invention, because the products of the refractive index temperature coefficients and the refractive index temperature coefficient change rates of the at least some lenses of the zoom lens are less than 0, the zoom lens may have consistent and favorable imaging quality in a normal temperature environment and a high temperature environment at both the wide-angle end and the telephoto end.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A and FIG. 1B respectively represent schematic diagrams of optical simulation of a known zoom lens in a normal temperature environment and a high temperature environment.

FIG. 2 is a schematic diagram showing that a zoom lens according to an embodiment of the invention is applied to an optical system.

FIG. 3 is a schematic diagram of the zoom lens in FIG. 2 in relative positions at a wide-angle end and a telephoto end respectively.

FIG. 4 is of a flowchart of a manufacturing method of a zoom lens 100 according to an embodiment of the invention.

FIG. 5 is a temperature gradient distribution diagram of a preset zoom lens at a wide-angle end and a telephoto end respectively.

FIG. 6A and FIG. 6B are each a longitudinal spherical aberration diagram, a field curve chart, and a distortion chart of a zoom lens at a wide-angle end and a telephoto end respectively.

FIG. 7A and FIG. 7B are each a ray fan plot of a zoom lens at a wide-angle end and a telephoto end respectively.

FIG. 8A and FIG. 8B are each a lateral chromatic aberration diagram of a zoom lens at a wide-angle end and a telephoto end respectively.

FIG. 9A and FIG. 9B are each a modulation transfer function (MTF) graph of a zoom lens in a normal temperature environment at a wide-angle end and a telephoto end respectively.

FIG. 10A and FIG. 10B are each a modulation transfer function graph of a zoom lens in a high temperature environment at a wide-angle end and a telephoto end respectively.

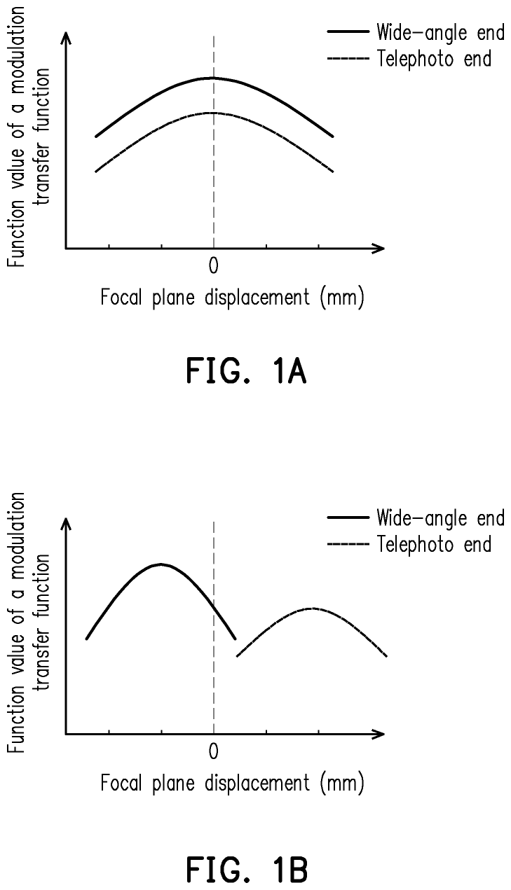

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

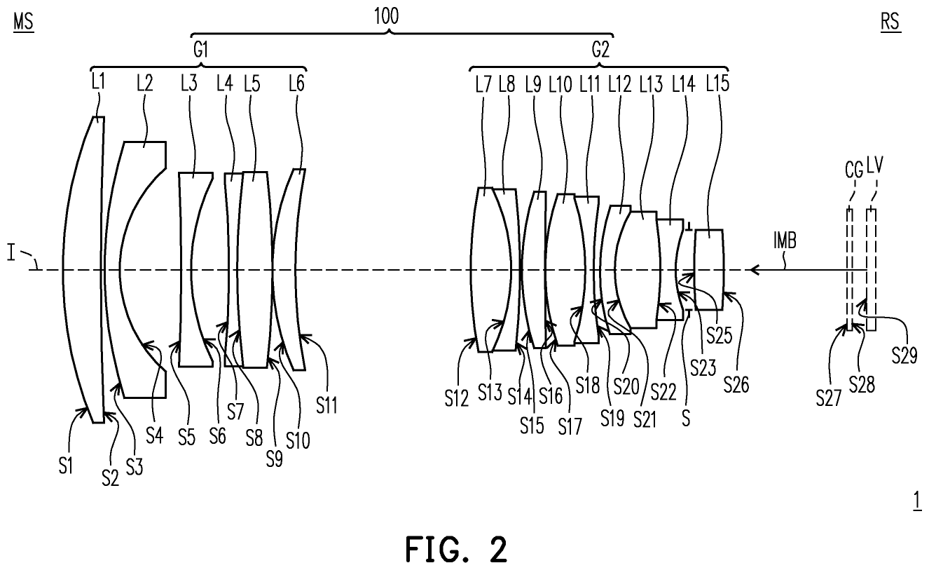

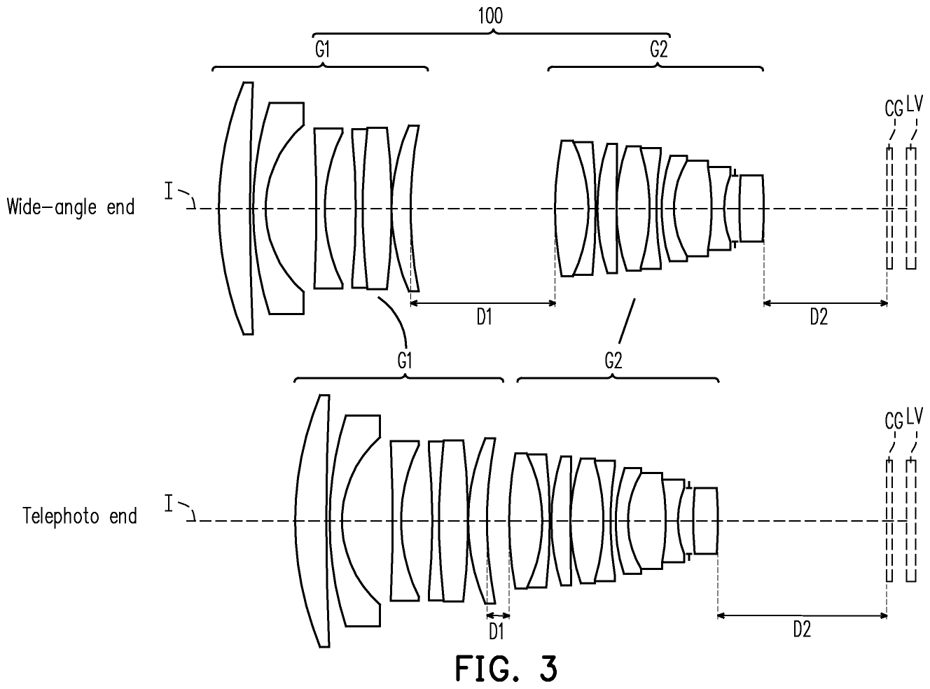

FIG. 2 is a schematic diagram showing that a zoom lens according to an embodiment of the invention is applied to an optical system. FIG. 3 is a schematic diagram of a zoom lens according to an embodiment of the invention in relative positions at a wide-angle end and a telephoto end respectively.

Referring to FIG. 2, in the embodiment, a zoom lens 100 may be, for example, applied to an optical system, the optical system may be a projector, a camera lens, a mobile phone lens, or the like, and a type of the optical system to which the zoom lens 100 is applied is not limited in the invention. For ease of description, in the following embodiment, for example, the optical system is a projector 1. The projector 1 includes a lighting system (not shown), a light valve LV, a cover glass CG, and a zoom lens 100. The zoom lens 100 is disposed between a magnified side MS and a reduced side RS. The magnified side MS refers to a side close to a projection screen (not shown), and the reduced side RS refers to a side close to the light valve LV. The magnified side MS may also be referred to as a screen side, and the reduced side RS may also be referred to as an image source side. Functions of the foregoing elements and a configuration relationship between the elements are described in detail in the following paragraphs.

The lighting system is configured to provide an illuminating beam (not shown) to the light valve LV.

The light valve LV may be any spatial light modulator such as a digital micro mirror device (DMD) or a liquid crystal on silicon (LCOS), and is configured to convert the illuminating beam into an image beam IMB.

The cover glass CG is configured to provide a protection function for the light valve LV.

A configuration manner of each element in the projector 1 is described in detail in the following paragraph.

The light valve LV and the cover glass CG are disposed on the reduced side RS. The zoom lens 100 is disposed between the reduced side RS and the magnified side MS. The light valve LV is disposed on a transmission path of the illuminating beam. The cover glass CG is disposed on a transmission path of the image beam IMB and is located between the zoom lens 100 and the light valve LV. The zoom lens 100 is disposed on the transmission path of the image beam IMB.

Referring to FIG. 2 again, the light valve LV converts the illuminating beam into the image beam IMB, and then the image beam IMB sequentially penetrates the cover glass CG and the zoom lens 100 along a direction from the reduced side RS to the magnified side MS and forms an image on a side of the magnified side MS of the zoom lens 100.

In the foregoing embodiment, the zoom lens 100 is, for example, applied to the projector 1. In other embodiments, the zoom lens 100 may be, for example, configured to capture an image, and the light valve LV may be replaced by a light sensitive device (not shown), and an imaging surface position of the zoom lens 100 is, for example, a position of a surface S29 of the light valve LV shown in FIG. 2. In this case, an imaging surface is located on a surface of the light sensitive device.

A configuration of each element in the zoom lens 100 is described in detail in the following paragraph.

Referring to FIG. 2, in the embodiment, the zoom lens 100 includes an optical axis I, and sequentially includes a movable first lens group G1 and a movable second lens group G2 along the optical axis I from the magnified side MS to the reduced side RS. The first and second lens groups G1 and G2 are movable lens groups. The first and second lens groups G1 and G2 each include at least one lens with a refractive power. If a lens group includes a plurality of lenses, the lenses move together when the lens group moves, and a distance between any two adjacent lenses in the lens group does not change with an adjustment of a focal length of the zoom lens 100. That is, each lens group is classified based on movability.

In the embodiment, the zoom lens 100 includes, for example, two movable lens groups. When the zoom lens 100 zooms, the first and the second lens groups G1 and G2 may respectively move relative to the light valve LV on the optical axis I, for switching between the wide-angle end and the telephoto end to perform a zoom operation. The wide-angle end and the telephoto end respectively refer to cases of adjusting the focal length to the shortest and the longest on a same lens. When the zoom lens 100 switches to the wide-angle end, the focal length is the shortest, maximum image magnification is achieved, and an image is projected in a largest range. When the zoom lens 100 switches to the telephoto end, the focal length is the longest, minimum image magnification is achieved, and an image is projected in a smallest range.

Referring to FIG. 3, when the zoom lens 100 switches from the wide-angle end to the telephoto end, the first lens group G1 may move to the reduced side RS along the optical axis I, and the second lens group may move to the magnified side MS along the optical axis I. In this case, variable distances D1 and D2 of the zoom lens 100 become smaller and larger respectively.

In the embodiment, the zoom lens 100 include, for example, 15 lenses with a refractive power. Lens arrangement manners, lens distances, refractive powers, materials, and lens shapes of the first and the second lens groups G1 and the G2 in the zoom lens 100 are described in detail in the following paragraph. A person skilled in the art may correspondingly change the foregoing lens design parameters according to requirements, and the invention is not limited thereto.

The first lens group G1 has a negative refractive power, and is sequentially provided with a first lens L1, a second lens L2, a third lens L3, a fourth lens L4, a fifth lens L5 and a sixth lens L6 along the optical axis I from the magnified side MS to the reduced side RS, whose refractive powers are respectively positive, negative, negative, negative, positive, and positive. The fourth lens L4 and the fifth lens L5 constitute a first double glued lens (for example, cemented doublet lens). In the embodiment, the first to the sixth lenses L1 to L6 are all spherical lenses. The first, the fifth, and the sixth lenses L1, L5, and L6 are made of glass.

The second lens group G2 has a positive refractive power, and is sequentially provided with a seventh lens L7, an eighth lens L8, a ninth lens L9, a tenth lens L10, an eleventh lens L11, a twelfth lens L12, a thirteenth lens L13, a fourteenth lens L14, and a fifteenth lens L15 along the optical axis I from the magnified side MS to the reduced side RS, whose refractive powers are respectively positive, negative, positive, positive, negative, negative, positive, negative, and positive. The seventh lens L7 and the eighth lens L8 constitute a second double glued lens, the tenth lens L10 and the eleventh lens L11 constitute a third double glued lens, and the twelfth lens L12, the thirteenth lens L13, and the fourteenth lens L14 constitute a triple glued lens. In the embodiment, the seventh, the ninth, and the fifteenth lenses L7, L9, and L15 are made of glass. In the embodiment, the seventh to the fourteenth lenses L7 to L14 are all spherical lenses, and the fifteenth lens is an aspheric lens.

In addition, referring to FIG. 2, in the embodiment, the zoom lens 100 further includes an aperture S (or referred to as an aperture diaphragm). The aperture S refers to an element that limits a beam in a lens and is configured to control an aperture size or an aperture range of the lens. In the embodiment, the aperture S is disposed between two lenses in the second lens group G2, and for example, is disposed between the fourteenth lens L14 and the fifteenth lens L15. However, a person skilled in the art may correspondingly change a position of the aperture according to requirements when needed, and the invention is not limited thereto.

It should be noted that, two adjacent faces of two adjacent lenses of the glued lenses mentioned in the embodiment have same or similar curvature radii, and the two adjacent faces of the lenses may be glued in different manners. For example, the two adjacent faces may be coated with optical glue or laminated by using a mechanism member, and this is not limited.

In the zoom lens 100, each lens has a magnifying side surface facing the magnified side MS and allowing the image beam IMB to pass and a reduction side surface facing the reduced side RS and allowing the image beam IMB to pass. Corresponding shapes of the foregoing lenses are described in detail in the following paragraph.

In the first lens group G1, a magnifying side surface S1 of the first lens L1 is a convex surface, and a reduction side surface S2 thereof is a concave surface. A magnifying side surface S3 of the second lens L2 is a convex surface, and a reduction side surface S4 thereof is a concave surface. A magnifying side surface S5 of the third lens L3 is a concave surface, and a reduction side surface S6 thereof is also a concave surface. A magnifying side surface S7 of the fourth lens L4 is a concave surface, and a reduction side surface (not shown) thereof is a concave surface. A magnifying side surface S8 of the fifth lens L5 is a convex surface, and a reduction side surface S9 thereof is also a convex surface. A magnifying side surface S10 of the sixth lens L6 is a convex surface, and a reduction side surface S11 thereof is also a concave surface.

In the second lens group G2, a magnifying side surface S12 of the seventh lens L7 is a convex surface, and a reduction side surface (not shown) thereof is also a convex surface. A magnifying side surface S13 of the eighth lens L8 is a concave surface, and a reduction side surface S14 thereof is a convex surface. A magnifying side surface S15 of the ninth lens L9 is a convex surface, and a reduction side surface S16 thereof is a concave surface. A magnifying side surface S17 of the tenth lens L10 is a convex surface, and a reduction side surface (not shown) thereof is also a convex surface. A magnifying side surface S18 of the eleventh lens L11 is a concave surface, and a reduction side surface S19 thereof is also a concave surface. A magnifying side surface S20 of the twelfth lens L12 is a convex surface, and a reduction side surface (not shown) thereof is a concave surface. A magnifying side surface S21 of the thirteenth lens L13 is a convex surface, and a reduction side surface (not shown) thereof is also a convex surface. A magnifying side surface S22 of the fourteenth lens L14 is a concave surface, and a reduction side surface S23 thereof is also a concave surface. A magnifying side surface S25 of the fifteenth lens L15 is a convex surface, and a reduction side surface S26 thereof is a convex surface.

In addition, the cover glass CG has a magnifying side surface S27 and a reduction side surface S28. The light valve LV has a reflective surface S29.

Lens design parameters of the zoom lens 100 and design parameters of the cover glass CG and the light valve LV are shown in the following Table 1. Corresponding design parameters of the variable distances D1 and D2 of the zoom lens 100 at the wide-angle end and the telephoto end respectively and related optical parameters are shown in the following Table 2, a total lens length is, for example, defined as a distance of the magnifying side surface S1 of the first lens L1 to the reduction side surface S26 of the fifteenth lens L15 on the optical axis I, and F# is an f-number. However, data listed below is not intended to limit the invention, and any person skilled in the art may make appropriate modifications to the parameters or settings with reference to the invention, provided that such modifications fall within the scope of the invention. A symbol * in a surface column represents an aspheric surface, and a cell without the symbol represents a spheric surface. A distance in Table 1 refers to a straight-line distance between two adjacent surfaces on the optical axis I. Specifically, a distance corresponding to the surface S1 is a straight-line distance between the surface S1 and the surface S2 on the optical axis I, a distance corresponding to the surface S2 is a straight-line distance between the surface S2 and the surface S3 on the optical axis I, and so on. In addition, that a curvature radius of a surface in Table 1 is infinite (co) means that the surface is flat.

TABLE 1

| | | Curvature | | | |
|---|---|---|---|---|---|
| | | radius | Distance | Refractive | Abbe |
| Element | Surface | (mm) | (mm) | index | coefficient |
| First lens L1 | S1 | 75.61 | 6.3 | 1.60300 | 65.44 |
| | S2 | 743.79 | 0.5 | — | — |
| Second lens L2 | S3 | 76.78 | 2.4 | 1.74320 | 49.34 |
| | S4 | 22.77 | 10.8 | — | — |
| Third lens L3 | S5 | −331.03 | 1.8 | 1.74950 | 35.28 |
| | S6 | 35.60 | 6.3 | — | — |
| Fourth lens L4 | S7 | −226.73 | 1.7 | 1.80100 | 34.97 |
| Fifth lens L5 | S8 | 149.63 | 5.8 | 1.80810 | 22.76 |
| | S9 | −184.90 | 0.3 | — | — |
| Sixth lens L6 | S10 | 44.11 | 3.9 | 1.80810 | 22.76 |
| | S11 | 89.74 | D1 | — | — |
| Seventh lens L7 | S12 | 71.18 | 7.0 | 1.48749 | 70.24 |
| Eighth lens L8 | S13 | −30.27 | 1.5 | 1.80610 | 40.93 |
| | S14 | −134.56 | 0.3 | — | — |
| Ninth lens L9 | S15 | 44.18 | 3.9 | 1.48749 | 70.24 |
| | S16 | 531.24 | 0.3 | — | — |
| Tenth lens L10 | S17 | 47.62 | 6.6 | 1.80610 | 40.93 |
| Eleventh lens | S18 | −44.00 | 1.6 | 1.72000 | 50.23 |
| L11 | S19 | 76.43 | 1.0 | — | — |
| Twelfth lens L12 | S20 | 33.19 | 2.5 | 1.62004 | 36.26 |
| Thirteenth lens | S21 | 19.10 | 8.0 | 1.72000 | 50.23 |
| L13 | | | | | |
| Fourteenth lens | S22 | −50.34 | 2.5 | 1.74000 | 28.30 |
| L14 | S23 | 19.89 | 2.4 | — | — |
| Aperture S | — | Infinite | 0.7 | — | — |
| Fifteenth lens | *S25 | 68.46 | 5.2 | 1.68987 | 53.27 |
| L15 | *S26 | −80.07 | D2 | — | — |
| CG | S27 | Infinite | 1.1 | 1.50998 | 60.97 |
| | S28 | Infinite | 0.7 | — | — |
| LV | S29 | Infinite | 0.0 | — | — |

TABLE 2

| | Wide-angle | Telephoto |
|---|---|---|
| | end | end |
| D1 | 30.22 | 4.73 |
| (Unit: mm) | | |
| D2 | 26.34 | 36.26 |
| (Unit: mm) | | |
| F# (f-number) | 2.23 | 2.88 |
| Effective focal length | 20.68 (fw) | 32.76 |
| (Unit: mm) | | |
| Total lens length | 113.52 | 88.03 |
| (Unit: mm) | | |

Moreover, in the embodiments of the invention, an aspheric surface polynomial may be expressed by using the following formula (1):

$$Z = \frac{{cr}^{2}}{1 + \sqrt{1 - ( 1 + k ) {c}^{2} {r}^{2}}} + {Ar}^{4} + {Br}^{6} + {Cr}^{8} + {Dr}^{10} + {Er}^{12} + {Fr}^{14} \qquad ( 1 )$$

In the foregoing formula (1), Z is an offset (sag) of a direction of the optical axis I, r is a curvature radius in a position close to the optical axis I, K is a quadratic surface coefficient (conic constant), c is an aspheric surface height, that is a height from a lens center to a lens edge, and A to F each represents each aspheric surface coefficient of the aspheric surface polynomial. The following Table 3 lists aspheric surface coefficients and values of the quadratic surface coefficients of S25 and S26.

TABLE 3

| | S25 | S26 |
|---|---|---|
| k | 0 | 0 |
| A | −2.6388E−05 | −7.0671E−06 |
| B | −3.0495E−08 | 3.5276E−09 |
| C | −1.0803E−10 | −1.3703E−10 |
| D | −4.2573E−12 | −6.5067E−12 |
| E | 9.2575E−14 | 1.4101E−13 |
| F | 1.8918E−22 | 1.8919E−22 |

In the embodiment, the zoom lens 100 meets a condition, and the condition is: products of refractive index temperature coefficients (temperature coefficient of refractive index, denoted as

$$\frac{dn}{dt} ,$$

where do is a change in a lens refractive index, dt is a change in a temperature, and t is the temperature) of at least some of the lenses L1 to L15 in the first lens group G1 and the second lens group G2 and refractive index temperature coefficient change rates (denoted as

$$\frac{{d}^{2} n}{{d}^{2} t} )$$

are less than 0, that is

$$( \frac{dn}{dt} \times \frac{{d}^{2} n}{{d}^{2} t} ) < 0 ,$$

where the refractive index temperature coefficient represents a change caused by a unit temperature in a lens refractive index, and the refractive index temperature coefficient change rate represents a change rate of a refractive index temperature coefficient with the temperature, that is, the refractive index temperature coefficient is further used to differentiate the temperature. In other words, in a process of manufacturing the zoom lens 100, when materials of at least some of the lenses L1 to L15 are selected, the foregoing condition needs to be met.

To meet the condition

$$( \frac{dn}{dt} \times \frac{{d}^{2} n}{{d}^{2} t} ) < 0 ,$$

in some embodiments, refractive index temperature coefficients

$$\frac{dn}{dt}$$

and refractive index temperature coefficient change rates

$$\frac{{d}^{2} n}{{d}^{2} t}$$

of at least some of the lenses L1 to L15 may be designed as positive values (+) and negative values (−) respectively. In some other embodiments, refractive index temperature coefficients

$$\frac{dn}{dt}$$

and refractive index temperature coefficient change rates

$$\frac{{d}^{2} n}{{d}^{2} t}$$

of at least some of the lenses L1 to L15 may be designed as negative values (−) and positive values (+) respectively. In still other embodiments, refractive index temperature coefficients

$$\frac{dn}{dt}$$

and refractive index temperature coefficient change rates

$$\frac{{d}^{2} n}{{d}^{2} t}$$

of one part of the at least some of the lenses L1 to L15 may be designed as positive values (+) and negative values (−), and refractive index temperature coefficients

$$\frac{dn}{dt}$$

and refractive index temperature coefficient change rates

$$\frac{{d}^{2} n}{{d}^{2} t}$$

of another part of the at least some of the lenses L1 to L15 may be designed as negative values (−) and positive values (+). The invention is not limited thereto.

Specifically, in the embodiment, the first, the fifth, the sixth, the seventh, and the ninth lenses L1, L5, L6, L7, and L9 meet the foregoing condition

$$( \frac{dn}{dt} \times \frac{{d}^{2} n}{{d}^{2} t} ) < 0 .$$

In the following paragraph, an effect of the foregoing condition and a basis for selecting the foregoing lenses are described in detail in combination with a manufacturing method.

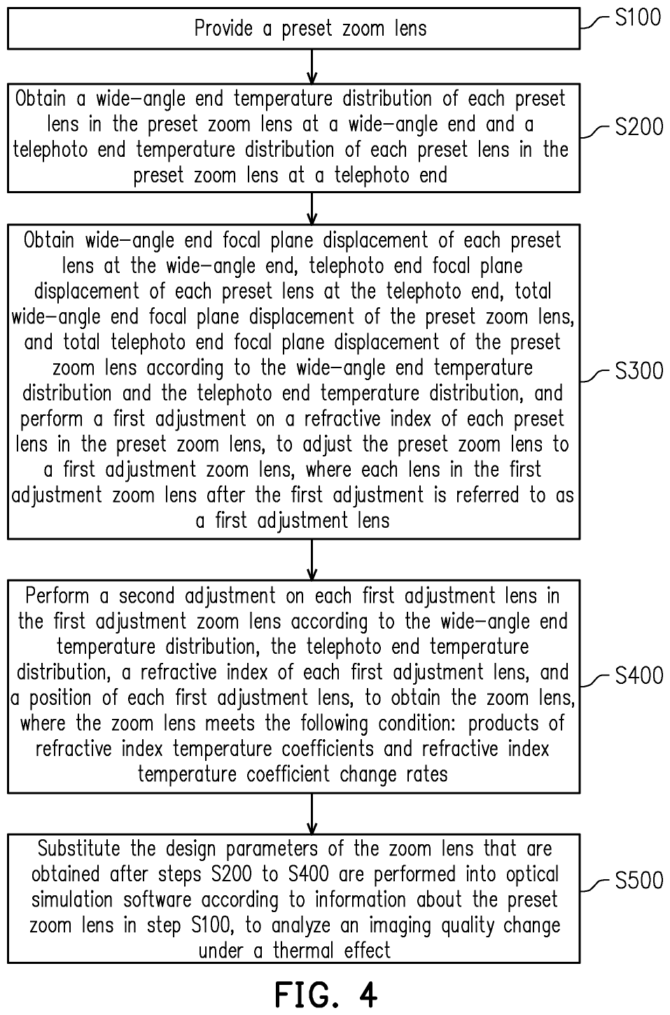

FIG. 4 shows a manufacturing method of the zoom lens 100, including the following steps S100 to S500, which are to be described in detail in the following paragraph.

Step S100: Provide a preset zoom lens. In this step, a person skilled in the art may design lens-related parameters such as a lens quantity of the preset zoom lens, a lens group, a lens surface shape, and a lens distance according to requirements, or may select a matching lens model based on a standard model zoom lens. A lens included in the preset zoom lens is referred to as a preset lens, that is, an unadjusted lens. In step S100, it is assumed that the preset zoom lens is designed as including a movable first lens group and a movable second lens group sequentially disposed along an optical axis from a magnifying side to a reduction side, and lens qualities, surface shapes, distances, and the like of the first and the second lens groups are the same as those in FIG. 2 and FIG. 3. However, the invention is not limited thereto. In other embodiments, the lens qualities, surface shapes, distances, and the like of the first and the second lens groups are similar to those in the embodiments of FIG. 2 and FIG. 3.

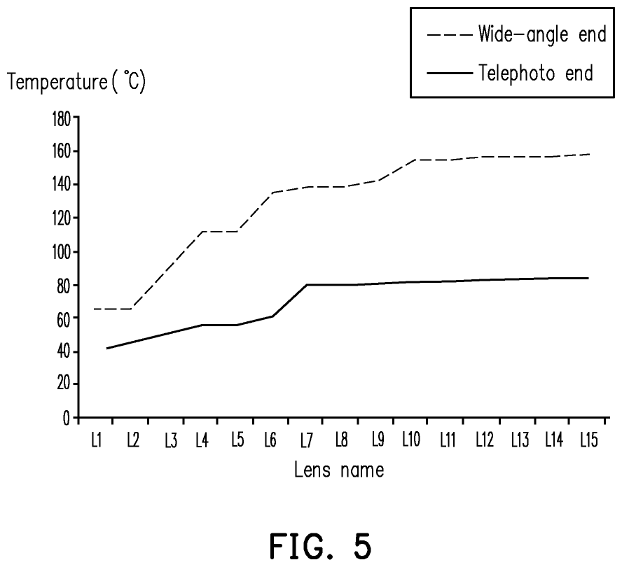

Step S200: Obtain a wide-angle end temperature distribution of each preset lens in the preset zoom lens at a wide-angle end and a telephoto end temperature distribution of each preset lens in the preset zoom lens at a telephoto end. As shown in FIG. 5, FIG. 5 is a temperature gradient distribution diagram of a preset zoom lens at a wide-angle end and a telephoto end respectively. Specifically, the wide-angle end temperature distribution and the telephoto end temperature distribution are obtained as follows: Simulation is performed according to a temperature of an environment in which the preset zoom lens is located, wattage of a light source (for example, wattage of a laser source in a lighting system) used by the preset zoom lens, a material of each preset lens in the preset zoom lens, and a material of a lens barrel of the preset zoom lens, to obtain the wide-angle end temperature distribution and the telephoto end temperature distribution. Values of the simulation are shown in the following Table 4. FIG. 5 is a graph formulated according to Table 4. It may be learned from Table 4 and FIG. 5 that a temperature change range at the wide-angle end falls within a range of 41° C. to 84° C. in a direction from an magnified side MS to an reduced side RS, and a temperature change range at the telephoto end falls within a range of 64° C. to 158° C. in the direction from the magnified side MS to the reduced side RS.

TABLE 4

| Lens | L1 | L2 | L3 | L4 | L5 | L6 | L7 |
|---|---|---|---|---|---|---|---|
| Wide-angle end | 41 | 45 | 50 | 55 | 55 | 60 | 80 |
| (Unit: ° C.) | | | | | | | |
| Telephoto end | 64 | 64 | 87 | 110 | 110 | 133 | 137 |
| (Unit: ° C.) | | | | | | | |

| Lens | L8 | L9 | L10 | L11 | L12 | L13 | L14 | L15 |
|---|---|---|---|---|---|---|---|---|
| Wide-angle end | 80 | 81 | 82 | 82 | 83 | 83 | 84 | 84 |
| (Unit: ° C.) | | | | | | | | |
| Telephoto end | 137 | 141 | 153 | 153 | 156 | 156 | 156 | 158 |
| (Unit: ° C.) | | | | | | | | |

Step S300: Obtain wide-angle end focal plane displacement of each preset lens at the wide-angle end, telephoto end focal plane displacement of each preset lens at the telephoto end, total wide-angle end focal plane displacement of the preset zoom lens, and total telephoto end focal plane displacement of the preset zoom lens according to the wide-angle end temperature distribution and the telephoto end temperature distribution, and perform a first adjustment on refractive indexes of at least some preset lenses in the preset zoom lens, to adjust the preset zoom lens to a first adjustment zoom lens, where each lens in the first adjustment zoom lens after the first adjustment is referred to as a first adjustment lens.

Specifically, the wide-angle end focal plane displacement of each preset lens at the wide-angle end and the telephoto end focal plane displacement of each preset lens at the telephoto end may be obtained in a method by using the following formula (2):

$$S = {\sum }_{i = 1}^{N} \{ Δ {T}_{i} [ {α}_{i} \cdot {L}_{i} ] + ( \frac{dn}{dt} ) ( {n}_{i} + {P}_{i} ) \} \qquad ( 2 )$$

S represents total focal plane displacement of the preset zoom lens (i.e., value of S), N represents a total quantity of all preset lens surfaces of the preset zoom lens, i represents a lens surface of any lens in the preset zoom lens, ΔTᵢ represents a temperature variation of an environment in which the lens surface is located, a, represents a thermal expansion coefficient of a medium between the lens surface and a next lens surface in the direction from the magnified side MS to the reduced side RS, Lᵢ represents a thickness of the medium along the optical axis of the preset zoom lens,

$$\frac{dn}{dt}$$

represents a refractive index temperature coefficient of the medium in a temperature range of 60 degrees to 80 degrees, nᵢ represents a refractive index of the medium, and Pᵢ represents a refractive power of the medium.

For example, assuming that i=1, representing a magnifying side surface S1 of a first lens L1, a medium between the magnifying side surface S1 and a next lens surface in the direction from the magnified side MS to the reduced side RS is a material used by the first lens L1. Therefore, α₁ is a thermal expansion coefficient of the material used by the first lens L1, and L₁ is a thickness of the material of the first lens L1 between the magnifying side surface S1 and a reduction side surface S2 on the optical axis I. In this case,

$$\frac{dn}{dt}$$

represents a refractive index temperature coefficient of the material used by the first lens L1 in a range of 60 degrees to 80 degrees, and n₁ and P₁ represent a refractive index and a refractive power of the material used by the first lens L1. Assuming that i=2, representing the reduction side surface S2 of the first lens L1, a medium between the reduction side surface S2 and a next lens surface in the direction from the magnified side MS to the reduced side RS is an air gap. Therefore, α₂ is a thermal expansion coefficient of the air, and L₂ is a thickness from the reduction side surface S2 of the first lens L1 to a magnifying side surface S3 of a second lens L2 on the optical axis I. In this case,

$$\frac{dn}{dt}$$

represents a refractive index temperature coefficient of the air in arrange of 60 degrees to 80 degrees, and n₂ and P₂ represent a refractive index and a refractive power of the airt. The rest can be deduced by analogy, and the details thereof are omitted herein.

Therefore, when the preset zoom lens switches to the wide-angle end and the telephoto end respectively, parameters of each preset lens and the corresponding medium may be substituted into the foregoing formula (2) to obtain the wide-angle end focal plane displacement of each preset lens at the wide-angle end (that is, a contribution of each preset lens to the total wide-angle end focal plane displacement at the wide-angle end), the telephoto end focal plane displacement of each preset lens at the telephoto end (that is, a contribution of each preset lens to the total telephoto end focal plane displacement at the telephoto end), the total wide-angle end focal plane displacement of the preset zoom lens, and the total telephoto end focal plane displacement of the preset zoom lens.

Subsequently, the first adjustment is performed on the refractive index of each preset lens in the preset zoom lens according to the wide-angle end focal plane displacement of each preset lens at the wide-angle end, the telephoto end focal plane displacement of each preset lens at the telephoto end, the total wide-angle end plane displacement of the preset zoom lens, and the total telephoto end plane displacement of the preset zoom lens, to obtain a first adjustment zoom lens, and a difference between values of S of the first adjustment zoom lens after the first adjustment at the wide-angle end and the telephoto end falls within a range of 0.1 mm to 0.2 mm. In the foregoing paragraph, the “performing the first adjustment on the refractive index of each preset lens” means replacing materials of at least some preset lenses without changing lens surface shapes, lens arrangement manners, and lens distances, to adjust the value of the refractive index temperature coefficient

$$( \frac{dn}{dt} )$$

of the preset lens and positive and negative values.

Specifically, in terms of a single positive lens, when

$$\frac{dn}{dt}$$

of the lens is a positive value, a refractive index of the lens increases after an ambient temperature increases, causing a wide-angle end focal plane and a telephoto end focal plane to drift towards the magnified side MS. When the

$$\frac{dn}{dt}$$

of the lens is a negative value, the refractive index of the lens decreases after the ambient temperature increases, causing the wide-angle end focal plane and the telephoto end focal plane to drift towards the reduced side RS. After the first adjustment is performed according to the foregoing parameters, the difference between the values of S of the first adjustment zoom lens at the wide-angle end and the telephoto end may fall within a range of 0.1 mm to 0.2 mm. In other words, a distance between a wide-angle end focal plane and a telephoto end focal plane of the preset zoom lens on which the first adjustment has not been performed is quite large. However, after the first adjustment is performed, a distance between the wide-angle end focal plane and the telephoto end focal plane of the first adjustment zoom lens may fall within a relatively small range. In other words, the first adjustment in step S300 is a coarse adjustment performed on the preset zoom lens, to compensate for a focal plane offset caused by a thermal effect due to the ambient temperature.

Step S400: Perform a second adjustment on at least some first adjustment lenses in the first adjustment zoom lens according to the wide-angle end temperature distribution, the telephoto end temperature distribution, a refractive index of each first adjustment lens, and a position of each first adjustment lens, to obtain the zoom lens 100, where the zoom lens 100 meets the following condition: products of refractive index temperature coefficients

$$\frac{dn}{dt}$$

and refractive index temperature coefficient change rates

$$\frac{{d}^{2} n}{{d}^{2} t}$$

of at least some lenses of the zoom lens 100 are less than 0, that is,

$$( \frac{dn}{dt} \times \frac{{d}^{2} n}{{d}^{2} t} ) < 0 .$$

Specifically, a first adjustment lens meeting a condition 1 and a condition 2 is selected for the second adjustment. The condition 1 is: selecting a first adjustment lens whose temperature differs greatly at the wide-angle end and the telephoto end from FIG. 5, where for example, a temperature difference is greater than 50° C.; however, the invention is not limited thereto. The condition 2 is: selecting a first adjustment lens having small impact on imaging quality from the condition 1. Then, the second adjustment is selectively performed on the first adjustment lens meeting the foregoing two conditions. In most cases, the first adjustment lens meeting the foregoing two conditions is usually a first adjustment lens that is located in the middle in the first and the second lens groups and whose lens type is a convex lens; however, the invention is not limited thereto. It is particularly noted that, according to different lens selection restrictions, the second adjustment may be performed on all first adjustment lenses meeting the foregoing two conditions, or only some first adjustment lenses may be adjusted. It is particularly noted that, the first adjustment lens selected for the second adjustment is not limited to the foregoing condition, and a lens may alternatively be selected according to a degree of impact of the lens on the imaging quality, for example, the first lens L1 may be selected; however, the invention is not limited thereto.

Subsequently, after to-be-adjusted first adjustment lenses are selected according to the foregoing rule, the second adjustment is then performed on the to-be-adjusted first adjustment lenses in material, to enable the lenses after the second adjustment to meet the condition:

$$\frac{dn}{dt}$$

### If

$$( \frac{dn}{dt} \times \frac{{d}^{2} n}{{d}^{2} t} ) < 0 .$$

of a to-be-adjusted first adjustment lens is a positive value, a material of the lens needs to be replaced to enable the lens to further meet a condition that

$$\frac{{d}^{2} n}{{d}^{2} t}$$

is a negative value. If

$$\frac{dn}{dt}$$

of a to-be-adjusted first adjustment lens is a negative value, a material of the lens needs to be replaced to enable the lens to further meet a condition that

$$\frac{{d}^{2} n}{{d}^{2} t}$$

is a positive value. In the embodiment, for example, the first, the fifth, the sixth, the seventh, and the ninth lenses L1, L5, L6, L7, and L9 meet the condition:

$$( \frac{dn}{dt} \times \frac{{d}^{2} n}{{d}^{2} t} ) < 0 .$$

It should be noted that, in other embodiments, if lens groups and a lens quantity adopted by the zoom lens are different from those in the foregoing embodiment, a to-be-adjusted first adjustment lens is selected also according to the foregoing condition 1 and condition 2, and the first, the fifth, the sixth, the seventh, and the ninth lens are not necessarily used as to-be-adjusted lenses.

To describe an effect of the foregoing condition:

$$( \frac{dn}{dt} \times \frac{{d}^{2} n}{{d}^{2} t} ) < 0 ,$$

it is assumed that an overall temperature of a projection zoom lens when switching to the wide-angle end is lower than that when switching to the telephoto end. For example, a positive lens meets only that

$$\frac{dn}{dt} > 0.$$

In this case, a contribution of the lens to an entire wide-angle end focal plane is: causing the wide-angle end focal plane to slightly drift towards the magnified side MS and causing an effective focal length to slightly decrease. A contribution of the lens to an entire telephoto end focal plane is: causing the telephoto end focal plane to greatly drift towards the magnified side MS and causing an effective focal length to greatly decrease. Alternatively, for example, a positive lens meets only that

$$\frac{dn}{dt} < 0.$$

In this case, a contribution of the lens to the entire wide-angle end focal plane is: causing the wide-angle end focal plane to slightly drift towards the reduced side RS and causing an effective focal length to slightly increase. A contribution of the lens to the entire telephoto end focal plane is: causing the telephoto end focal plane to greatly drift towards the reduced side RS and causing an effective focal length to greatly increase. Consequently, problems of focal plane drift differences of the wide-angle end and the telephoto end due to a great temperature gradient change cannot be resolved.

If after the foregoing second adjustment is performed on a lens, the lens meets, for example, that a refractive index temperature coefficient

$$\frac{dn}{dt}$$

and a refractive index temperature coefficient change rate

$$\frac{{d}^{2} n}{{d}^{2} t}$$

are respectively a positive value (+) and a negative value (−), when the zoom lens 100 switches to the wide-angle end and the temperature changes from a low temperature to a high temperature, the zoom lens 100 slightly drifts towards the magnified side MS in the wide-angle end focal plane, and the effective focal length slightly decreases; or when the zoom lens 100 switches to the telephoto end and the temperature changes from a low temperature to a high temperature, the zoom lens 100 slightly drifts towards the reduced side RS in the telephoto end focal plane, and the effective focal length increases.

If after the second adjustment is performed on a lens, the lens meets, for example, that a refractive index temperature coefficient

$$\frac{dn}{dt}$$

and a refractive index temperature coefficient change rate

$$\frac{{d}^{2} n}{{d}^{2} t}$$

are respectively a negative value (−) and a positive value (+), when the zoom lens 100 switches to the wide-angle end and the temperature changes from a low temperature to a high temperature, the zoom lens 100 slightly drifts towards the reduced side RS in the wide-angle end focal plane, and the effective focal length slightly decreases; or when the zoom lens 100 switches to the telephoto end and the temperature changes from a low temperature to a high temperature, the zoom lens 100 slightly drifts towards the magnified side MS in the telephoto end focal plane, and the effective focal length decreases.

In this way, the lens is made to meet the foregoing condition:

$$( \frac{dn}{dt} \times \frac{{d}^{2} n}{{d}^{2} t} ) < 0 ,$$

so that the focal plane drift differences of the wide-angle end and the telephoto end caused by temperature differences are compensated for, impact of the wide-angle end and the telephoto end on imaging quality of the zoom lens due to temperature differences is reduced, and adaptability of the zoom lens 100 at the wide-angle end and the telephoto end due to temperature differences is improved. In this case, the difference between the values of S of the zoom lens on which the first or the second adjustment has been performed at the wide-angle end and the telephoto end is less than 0.03 mm.

Step S500: Substitute the design parameters of the zoom lens 100 that are obtained after steps S200 to S400 are performed into optical simulation software (for example, Zemax optical simulation software) according to information about the preset zoom lens in step S100, to analyze an imaging quality change under a thermal effect.

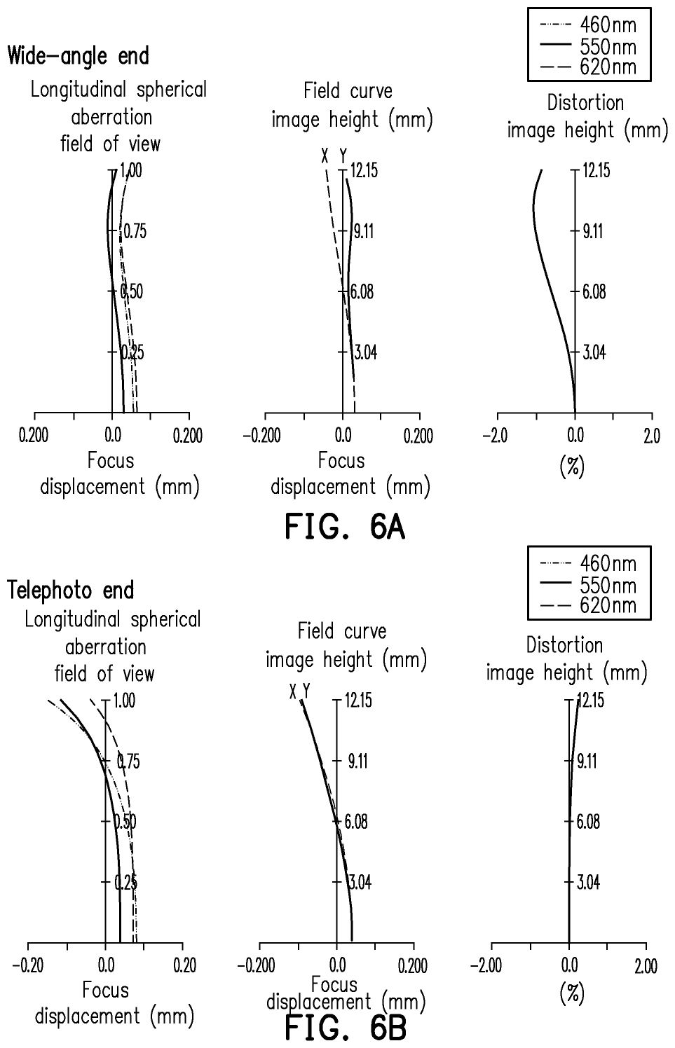

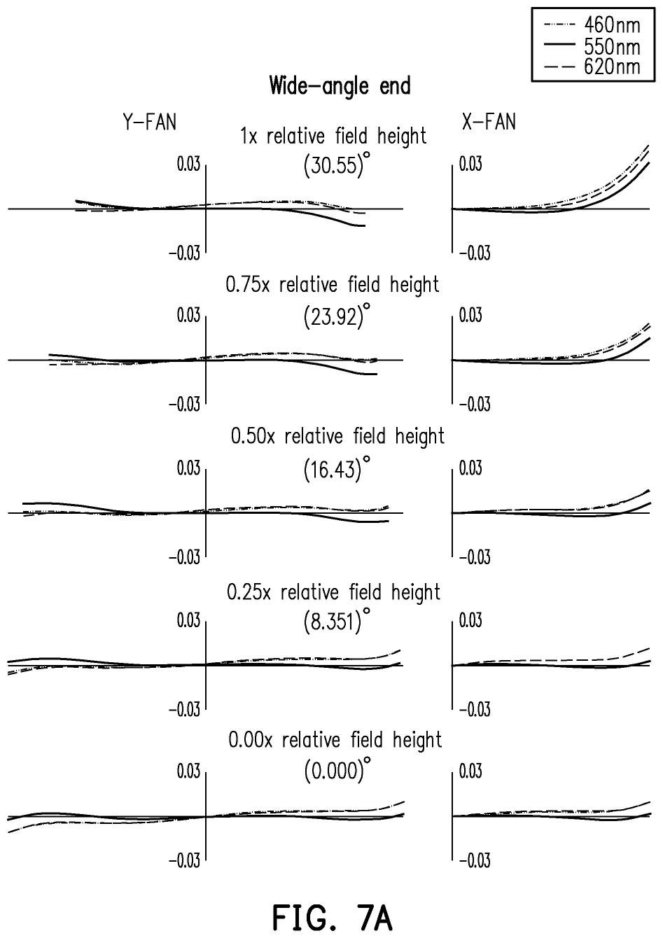

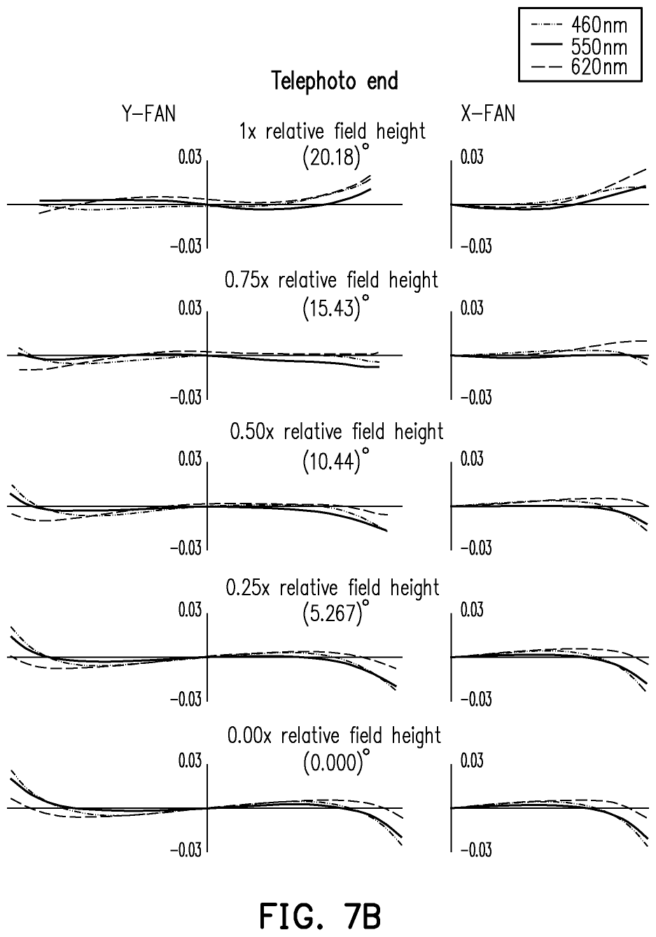

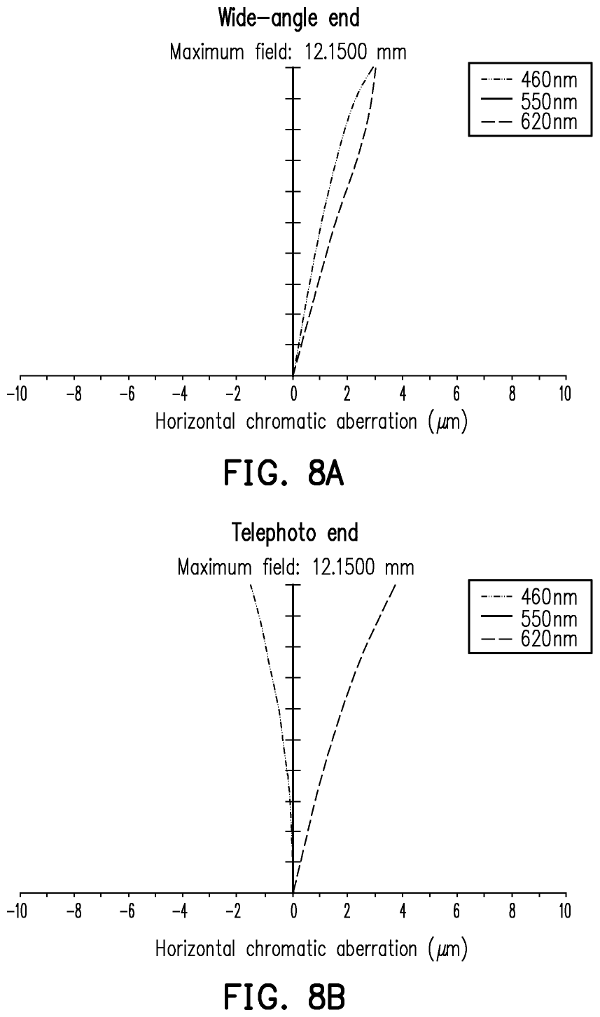

FIG. 6A and FIG. 6B are each a longitudinal spherical aberration diagram, a field curve chart, and a distortion chart of a zoom lens at a wide-angle end and a telephoto end respectively. In the field curve charts in FIG. 6A and FIG. 6B, a curve X is data in a sagittal direction, and a curve Y is data in a tangential. FIG. 7A and FIG. 7B are each a ray fan plot of a zoom lens at a wide-angle end and a telephoto end respectively. FIG. 8A and FIG. 8B are each a lateral chromatic aberration diagram of a zoom lens at a wide-angle end and a telephoto end respectively.

FIG. 6A to FIG. 8B are graphs obtained by simulation by using light with wavelengths of 620 nm, 550 nm, and 460 nm. The graphs shown in FIG. 6A to FIG. 8B all fall within a standard range, thereby verifying that the zoom lens 100 in the embodiment has favorable optical imaging quality.

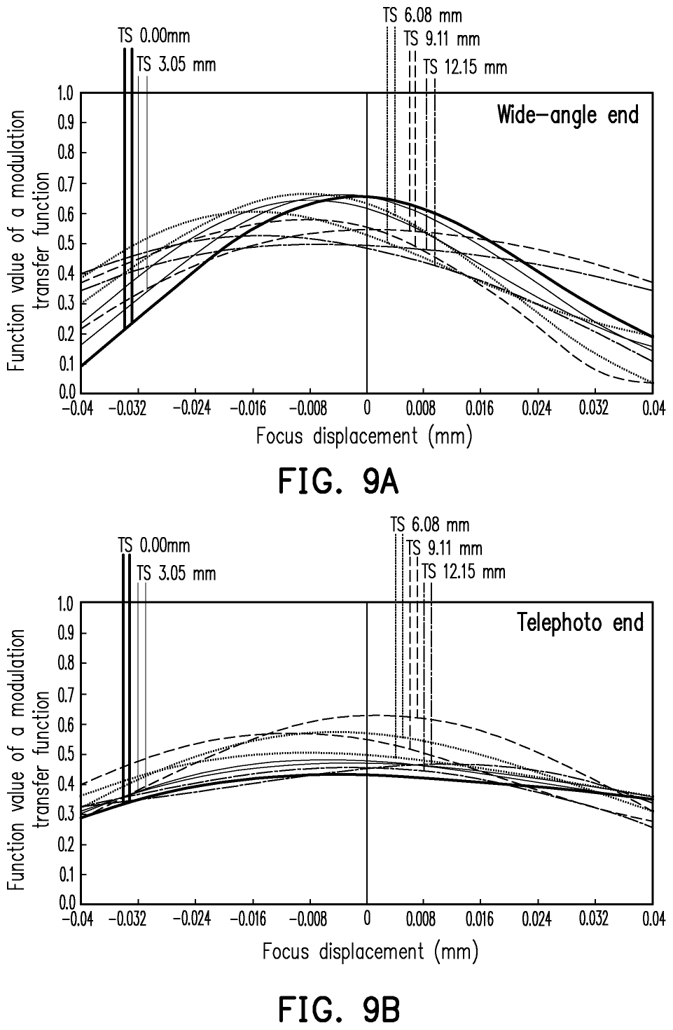

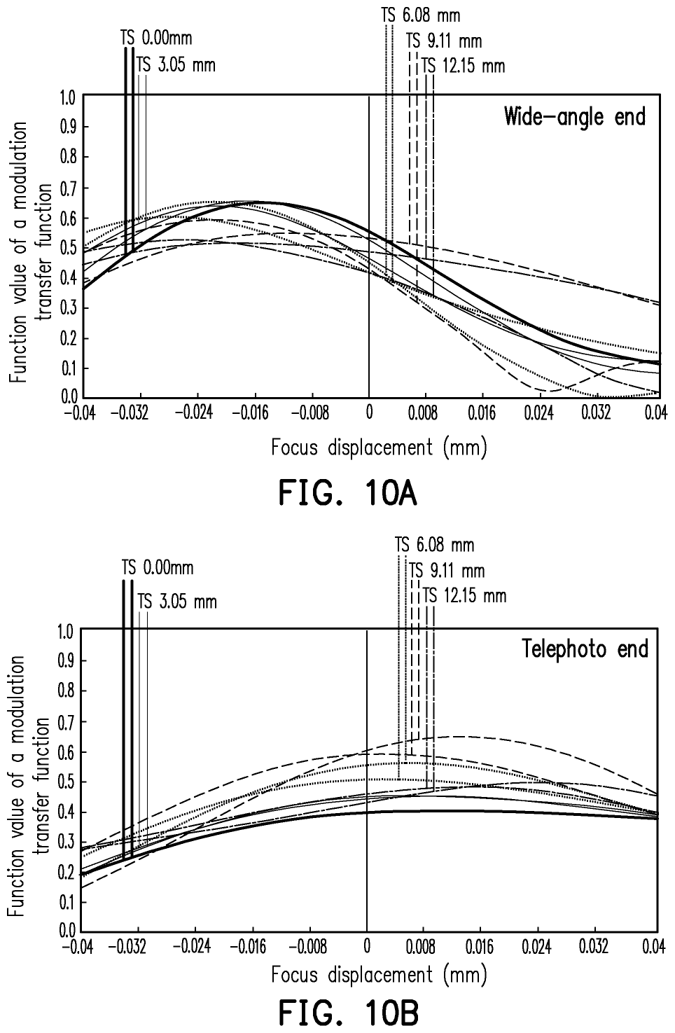

FIG. 9A and FIG. 9B are each an MTF (Modulation Transfer Function) graph of a zoom lens in a normal temperature environment at a wide-angle end and a telephoto end respectively. FIG. 10A and FIG. 10B are each a modulation transfer function graph of a zoom lens in a high temperature environment at a wide-angle end and a telephoto end respectively. A horizontal axis represents a focus shift, and a vertical axis represents a function value of an MTF. It may be learned from FIG. 9A to FIG. 10B that, function values of the MTF of the zoom lens 100 in the embodiment at a normal temperature and a high temperature at either the wide-angle end or the telephoto end are all more than 40%, and therefore, favorable imaging quality is achieved.

In addition, the zoom lens 100 of the embodiment may further meet the following conditional expressions (3) to (5):

1.6<|f1/fw|<2.5 (3)

1.3<|f2/fw|<2 (4)

1<|f1/f2|<1.5 (5)

f1 is an effective focal length of a first lens group G1, f2 is an effective focal length of a second lens group G2, and fw is an effective focal length of the zoom lens 100 at the wide-angle end. If the foregoing conditions (3) to (5) are met, for example, a 1.6× high-multiplier zoom effect may be achieved.

Based on the above, in the zoom lens in the embodiments of the invention, because the products of refractive index temperature coefficients and refractive index temperature coefficient change rates of at least some lenses are less than 0, a problem of thermal drift caused by different temperatures to the zoom lens in the high temperature environment and in the low temperature environment may be resolved, and a problem of thermal drift caused by different temperature distributions at the wide-angle end and the telephoto end to the zoom lens may also be resolved. The zoom lens is well adaptable to changes in the environment temperature and temperature distribution gradient differences at the wide-angle end and the telephoto end. In addition, in the manufacturing method of the zoom lens in the embodiments of the invention, as is more specifically described, particular lenses are selected according to different parameters to perform the first adjustment and the second adjustment on the preset zoom lens sequentially, to manufacture the foregoing zoom lens.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims.

What is claimed is:

1. A zoom lens, wherein the zoom lens comprises a movable first lens group and a movable second lens group sequentially arranged along an optical axis from a magnifying side to a reduction side, and the first lens group and the second lens group respectively comprises at least one lens, wherein
the zoom lens meets a condition as follows: a product of a refractive index temperature coefficient and a refractive index temperature coefficient change rate of at least some of the at least one lens of the first lens group and the second lens group is less than 0.

2. The zoom lens according to claim 1, wherein a refractive power of the first lens group is negative and a refractive power of the second lens group is positive.

3. The zoom lens according to claim 1, wherein the refractive index temperature coefficient and the refractive index temperature coefficient change rate of the at least some of the at least one lens are respectively a positive value and a negative value.

4. The zoom lens according to claim 1, wherein the refractive index temperature coefficient and the refractive index temperature coefficient change rate of the at least some of the at least one lens are respectively a negative value and a positive value.

5. The zoom lens according to claim 1, defined as the following conditional expression:
$$s = {\sum }_{i = 1}^{N} \{ Δ {T}_{i} [ {α}_{i} \cdot {L}_{i} ] + ( \frac{dn}{dt} ) ( {n}_{i} + {P}_{i} ) \} ,$$
wherein
S represents a total focal plane displacement of the zoom lens, N represents a total quantity of lens surfaces of the first lens group and the second lens group, i represents a lens surface of a lens in the first lens group and the second lens group, ΔTᵢ represents a temperature variation of an environment in which the lens surface is located, a, represents a thermal expansion coefficient of a medium between the lens surface and a next lens surface in a direction from the magnifying side to the reduction side, Lᵢ represents a thickness of the medium in the optical axis,
$$\frac{dn}{dt}$$
represents a refractive index temperature coefficient of the medium between a temperature range of 60 degrees to 80 degrees, nᵢ represents a refractive index of the medium, and Pᵢ represents a refractive power of the medium, wherein
a difference between values of S of the zoom lens at a wide-angle end and a telephoto end is less than 0.03 mm.

6. The zoom lens according to claim 1, wherein
the first lens group is sequentially provided with a first lens, a second lens, a third lens, a fourth lens, a fifth lens, and a sixth lens along the optical axis from the magnifying side to the reduction side; and
the second lens group is sequentially provided with a seventh lens, an eighth lens, a ninth lens, a tenth lens, an eleventh lens, a twelfth lens, a thirteenth lens, a fourteenth lens, and a fifteenth lens along the optical axis from the magnifying side to the reduction side.

7. The zoom lens according to claim 6, wherein
the fourth lens and the fifth lens constitute a first double glued lens, the seventh lens and the eighth lens constitute a second double glued lens, the tenth lens and the eleventh lens constitute a third double glued lens, and the twelfth lens, the thirteenth lens, and the fourteenth lens constitute a triple glued lens; and
the fifteenth lens is an aspheric lens and is made of glass.

8. The zoom lens according to claim 6, wherein
the first lens, the fifth lens, the sixth lens, the seventh lens, and the ninth lens meet the condition.

9. The zoom lens according to claim 6, wherein
in the first lens group, refractive powers of the first lens, the second lens, the third lens, the fourth lens, the fifth lens, and the sixth lens are sequentially positive, negative, negative, negative, positive, and positive; and
in the second lens group, refractive powers of the seventh lens, the eighth lens, the ninth lens, the tenth lens, the eleventh lens, the twelfth lens, the thirteenth lens, the fourteenth lens, and the fifteenth lens are sequentially positive, negative, positive, positive, negative, negative, positive, negative, and positive.

10. A manufacturing method of a zoom lens, comprising:
providing a preset zoom lens;
obtaining a wide-angle end temperature distribution of each preset lens in the preset zoom lens at a wide-angle end and a telephoto end temperature distribution of each preset lens in the preset zoom lens at a telephoto end;
obtaining a wide-angle end focal plane displacement of each of the preset lenses at the wide-angle end, a telephoto end focal plane displacement of each of the preset lenses at the telephoto end, a total wide-angle end focal plane displacement of the preset zoom lens, and a total telephoto end focal plane displacement of the preset zoom lens according to the wide-angle end temperature distribution and the telephoto end temperature distribution;
performing a first adjustment on a refractive index of at least some preset lenses in the preset zoom lens according to the wide-angle end focal plane displacement of each of the preset lenses, the telephoto end focal plane displacement of each of the preset lenses, the total wide-angle end plane displacement of the preset zoom lens, and the total telephoto end plane displacement of the preset zoom lens, to adjust the preset zoom lens to a first adjustment zoom lens, wherein each lens in the first adjustment zoom lens is a first adjustment lens; and
performing a second adjustment on at least some first adjustment lenses in the first adjustment zoom lens according to the wide-angle end temperature distribution, the telephoto end temperature distribution, a refractive index of each of the first adjustment lenses, and a position of each of the first adjustment lenses, to obtain the zoom lens, wherein the zoom lens meets a condition as follows:
a product of a refractive index temperature coefficient and a refractive index temperature coefficient change rate of at least some lenses of the zoom lens is less than 0.

11. The manufacturing method of a zoom lens according to claim 10, wherein the step of obtaining the wide-angle end temperature distribution and the telephoto end temperature distribution further comprises:
obtaining the wide-angle end temperature distribution and the telephoto end temperature distribution according to a temperature of an environment in which the preset zoom lens is located, a wattage of a light source used by the preset zoom lens, a material of each of the preset lenses in the preset zoom lens, and a material of a lens barrel of the preset zoom lens.
